(19) United States
(12) Patent Application Publication
(10) Pub. No.: US 2015/0344094 A1
(43) Pub. Date: Dec. 3, 2015

(54) PERSONALIZED MOTORCYCLE HAND OPERATING LEVERS FOR THE FRONT BRAKE AND CLUTCH

(71) Applicant: Edmond Douglas Monroe, San Lorenzo, CA (US)

(72) Inventor: Edmond Douglas Monroe, San Lorenzo, CA (US)

(21) Appl. No.: 14/729,711

(22) Filed: Jun. 3, 2015

Related U.S. Application Data
(60) Provisional application No. 62/007,043, filed on Jun. 3, 2014.

(51) Int. Cl. B62K 11/14; B62J 99/00; B62K 23/06

(52) U.S. Cl. CPC B62K 11/14; B62K 23/06; B62J 99/00; B62J 2099/0086

(57) ABSTRACT

A personalized motorcycle hand operating lever for the front brake or clutch is disclosed. Hand levers for operating the clutch and brake are positioned on the handlebars of a motorcycle inward of the hand grip, and an extension on the proximal end of the hand lever allows connection of one or more three-dimensional personalization symbols on the same plane as the handlebar and hand lever. The three-dimensional symbols can be an area code, geographical indicator, club insignia or anything of significance to the operator.

### CROSS REFERENCE TO RELATED APPLICATION

This application claims priority to and benefit of U.S. provisional application Ser. No. 62/007,043 entitled “Personalized motorcycle hand operating levers for the front brake and clutch”, filed Jun. 3, 2013 which is hereby incorporated by reference in its entirety.

### BACKGROUND THE INVENTION

This invention relates to motorcycles, and more particularly to personalization of the clutch and brake operating levers on motorcycles and other motorized vehicles using handlebars for steering.

The structural design of hand levers is typical dull so that they are not deeply accepted by young people. Prior art operating levers for motorcycles and other vehicles with handlebars typically have handgrips for steering which comprise a head at one end for being pivotably coupled to the handgrip and for being connected to the brake or clutch, and a handle portion adapted to be gripped by the fingers of the operator. The handle portion is typically rectangular or oval shaped, and itself may contain ornamentation or surface embellishments to enhance its value to the operator. U.S. Pat. No. 5,311,792 describes a tapered version of a handle that can be used with the present invention. However, these devices leave little leeway for employing distinctive ornamentation as may be desired by the operator.

The handle surface of prior art levers is connected to a connector connecting it to the head of the lever, the connector typically configured as a reverse ogee curve connecting two nonparallel lines which are generally adapted to aid the operator's grip on the handle portion and are rectangular in transverse section. The surface aforementioned lever facing toward the handgrip is generally flat and the surface of the lever facing away from the handgrip is slightly convex and not complementary to the handgrip surface. This adaptation limits the degree which the lever can be moved into proximity with the handgrip. Furthermore, prior art shapes for handgrips did not conform with the shape of the operator's fingers, thereby contributing to increased finger extension and undue physical discomfort.

### SUMMARY OF THE INVENTION

It is an object of the invention to provide a personalized means for ornamentation of a typical operating lever commonly employed on the handlebars for vehicles steered by handlebars, such as motorcycles, snowmobiles, jet skis, motor scooters and bicycles.

Another object of the invention is to provide personalized displays for motorcycle operating hand levers which serve to protect an operator's hand when shrubs or bushes encroach upon the right-of-way at the height of the handlebar.

It is an object of this invention to provide a means for aesthetically improving the appearance of the clutch or brake hand lever assembly in a personalized fashion while still allowing the levers to perform their functions. The personalized assembly for the hand levers allows individual operators to apply decorative designs or symbols in such a way as to make them immediately apparent to persons observing the motorcycle from the front. The personalized assemblies can contain three dimensional series of numbers, letters or symbols that extend outwardly from the junction of hand lever near where the lever is functionally joined to the handle.

These and other objects and advantages of the present invention will become more apparent from the detailed description thereof taken with the accompanying drawings.

### BRIEF DESCRIPTION OF THE DRAWINGS

FIG. 1 is a front perspective view of the personalized exhibitor display for a clutch hand lever assembly and hand grip of a motorcycle.

FIG. 2 is a front perspective view of the personalized display assembly for a brake hand lever assembly and hand grip of a motorcycle.

FIG. 3 is a perspective view of a personalized display assembly for a clutch hand lever assembly of a motorcycle.

FIG. 4 is a front view of a personalized display assembly for clutch hand lever assembly of a motorcycle.

FIG. 5 is a bottom perspective view of a personalized display assembly for a clutch hand operating lever assembly of a motorcycle.

FIG. 6 is a side perspective view of a personalized display assembly for a clutch or brake hand lever assembly of a motorcycle.

FIG. 7 is a top view of personalized display for the brake hand lever assembly of a motorcycle.

FIG. 8 is a top view of personalized display for the clutch hand lever assembly of a motorcycle.

FIG. 9 is a perspective view of a personalized clutch lever with an extension for the exhibitor display.

### DETAILED DESCRIPTION OF THE PREFERRED EMBODIMENTS

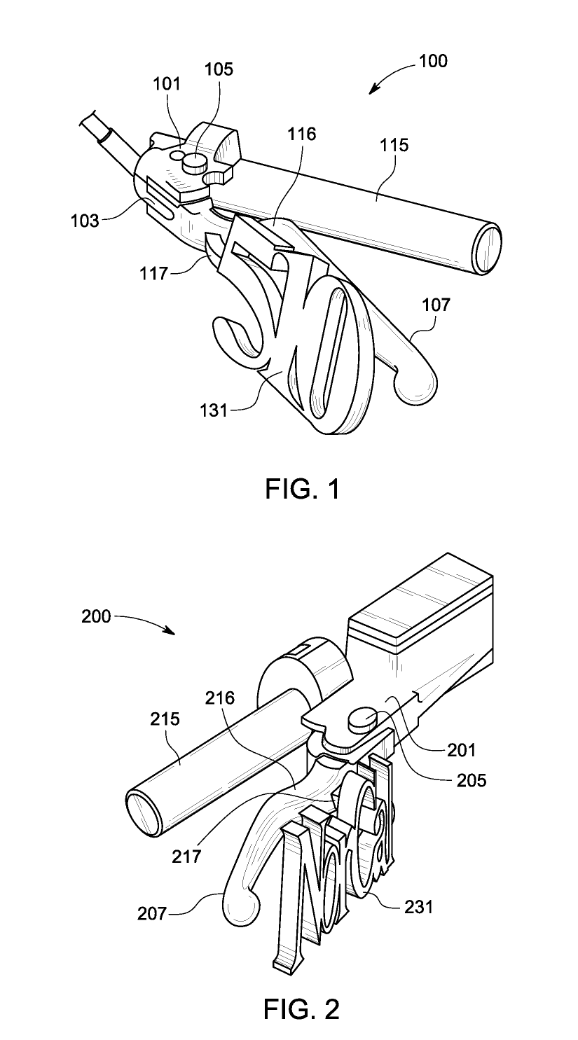

FIG. 1 shows a motorcycle clutch handgrip assembly 100 secured to handlebar adjacent to handgrip 115. The clutch handgrip assembly 100 includes a head portion 101 and a finger-engaged lever portion 107 connected by a connector portion 116. The head portion 101 contains at the proximal end openings 103 for receiving and securing a clutch cable, as well as an opening for receiving a hinge pin 105 for mounting clutch lever assembly 100 to the handlebar. Beginning near the proximal end and spaced apart from the handgrip 115, and extending outward in a typical fashion is the hand lever 107 by which the clutch is operated.

The present invention includes a head extension 117 extending outwardly from the connector portion 116 of the lever positioned between the head portion 101 of the clutch lever and the handle portion 107 of the lever. The proximal end of the head extension 117 may be formed integrally with the connector portion 116 attached to the head portion 101 of lever 107, or it may be attached to the connector or head by any typical means, such as welding, brazing, bolting, screwing or gluing. The distal end of the head extension 117 is adapted to receive a personalized three-dimensional display 131. The personalized display of 131 includes coupling means on the proximal end of the display.

FIG. 2 shows a motorcycle front brake handgrip assembly 200 secured to handlebar adjacent to handgrip 215. The brake handgrip assembly 200 includes a head portion 201 and at the opposite end, a finger-engaged lever portion 207 connected by a connector portion 216. The head portion 201 contains at the proximal end a cable or other means for operating the brake as well as an opening for receiving a hinge pin 205 for mounting front brake lever 200 to the handlebar. At the proximal end of the head assembly 201 extending outwardly in a typical fashion is the connector 216 which is also attached to hand lever 207 by which the brake is operated.

The present invention includes a head extension 217 extending outwardly from a connector portion 216 adjacent to the head portion 201 of the front brake lever. The proximal end of the head extension 217 may be formed integrally with the connector portion 216 between the head portion 201 and the lever portion of lever 207 of the lever assembly 200, or it may be attached to the connector by any typical means, such as welding, brazing, bolting, screwing or gluing. The distal end of the head extension 217 is adapted to receive a personalized three dimensional display 231.

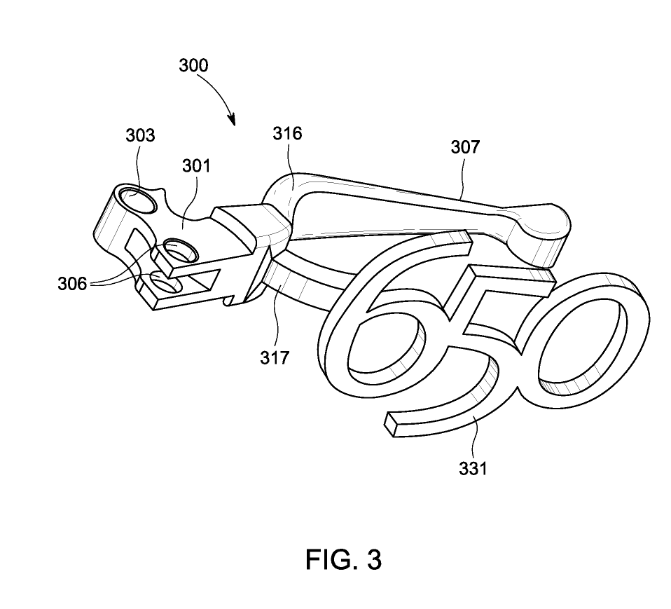

FIG. 3 is another view of the personalized clutch operating lever assembly of the present invention. A clutch lever assembly 300 includes a head portion 301 and a connector portion 316 extending away from the head portion, connecting to a finger-engaged lever portion 307. The head portion 301 contains at the proximal end openings 303 for receiving a hinge pin for mounting clutch lever 300 to the handlebar, as well as openings 306 for receiving and securing a clutch cable. Beginning near the proximal end of the handgrip assembly 300 at the head 301, and spaced apart from the handlebar handgrip by a connector 316, the hand lever 307 by which the clutch is operated extends outwardly in a typical fashion.

The present invention includes a head extension 317 extending outwardly from the connector portion 316 of the clutch lever. The proximal end of the head extension 317 may be formed integrally with the connector portion of 316 of the lever assembly 300, or it may be attached to the connector or head by any typical means, such as welding, brazing, bolting, screwing or gluing. The distal end of the head extension 317 is directly connected to, or adapted to receive a personalized three dimensional display 331.

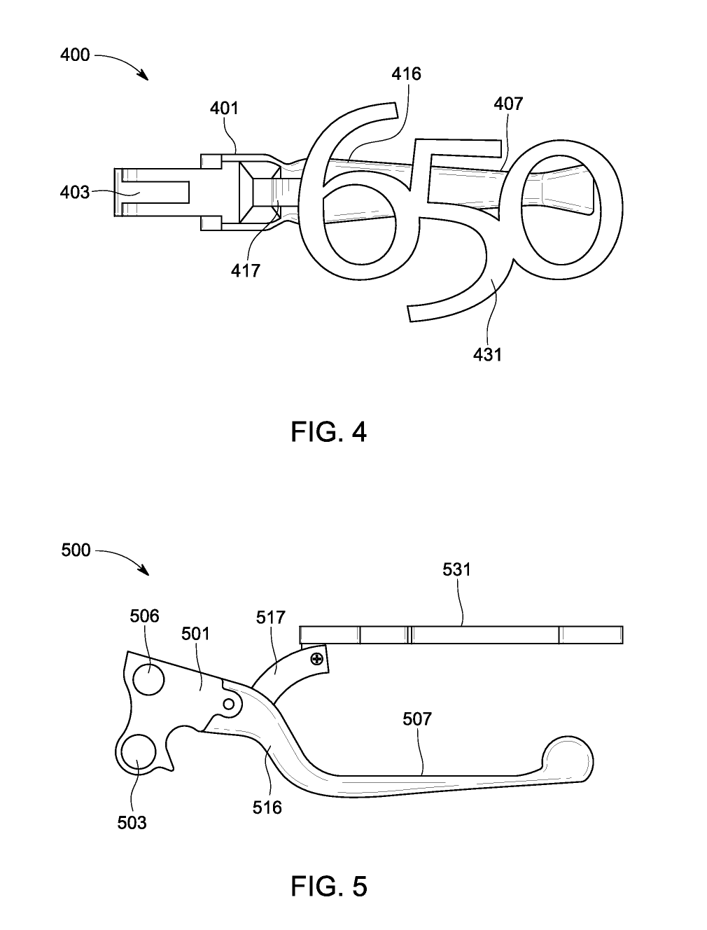

FIG. 4 is a front view of the personalized clutch assembly of the present invention. The clutch lever assembly 400 includes a head portion 401, a connector portion 416 which is connected to a finger-engaged lever portion 407. The head portion 401 of the clutch lever assembly contains at the proximal end openings 403 for receiving and securing a clutch cable. Beginning near the proximal end of the handgrip assembly 400 and spaced apart from the handlebar handgrip by the connector 416, the hand lever 407 by which the clutch is operated extends outwardly in a typical fashion.

The present invention includes a head extension 417 extending outwardly from the connector 416 connecting head portion 401 of the clutch lever to the lever portion 407 of the assembly. The proximal end of the head extension 417 is attached to the connector 416 of the clutch lever. The distal end of the head extension 417 is directly connected to, or adapted to receive a personalized three dimensional display 431.

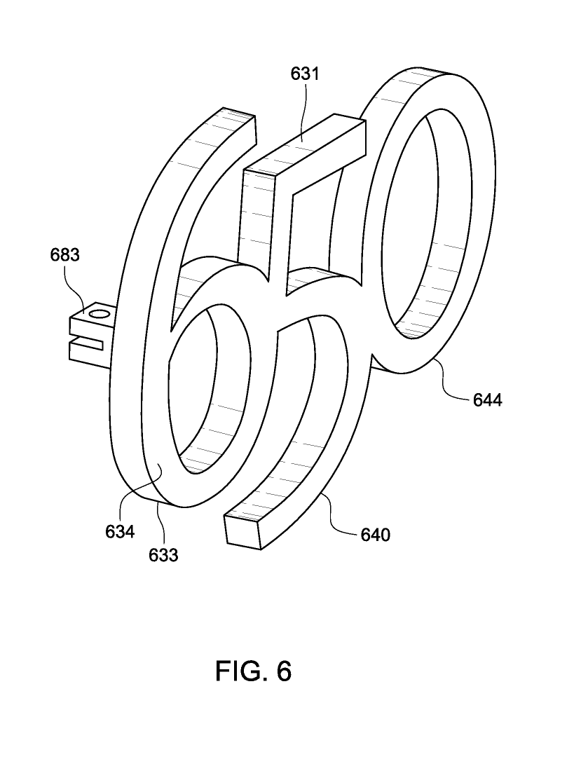

FIG. 5 is a bottom view of the personalized clutch assembly of the present invention. A clutch lever assembly 500 includes a head portion 501, a connector portion 516, and a finger-engaged lever portion 507. The head portion 501 contains at the proximal end openings 503 for receiving a hinge pin for mounting clutch operating lever 500 to the handlebar, as well as opening 506 for receiving and securing a clutch cable. Beginning near the proximal end of the handgrip assembly 500 and spaced apart from the handlebar handgrip, the hand lever 507 by which the clutch is operated extends outwardly from the connector portion 516 in a typical fashion.

The present invention includes a head extension 517 extending outwardly from the connector portion 516 of the clutch lever connecting the head portion 501 to the lever portion 507 of the clutch lever assembly 500. The proximal end of the head extension 517 is attached to the connector 516 which is attached to the head portion 501 of the hand operating lever. The distal end of the head extension 517 is directly connected to, or adapted to receive a personalized three dimensional display 531 of the present invention.

FIG. 6 is a perspective view of the front of the personalized exhibitor display 631. Display 631 consists of three connected numbers, horizontally connected so that the front of the numbers 633 (a “6”), 640 (a “5”) and 644 (a “0”) are displayed outwardly so as to be legible to a viewer at the front of the motorcycle. The display connector 683 is shown at the back of the lead number so that the display can be removably attached to an extension extending from the head of either a clutch or front brake lever assembly.

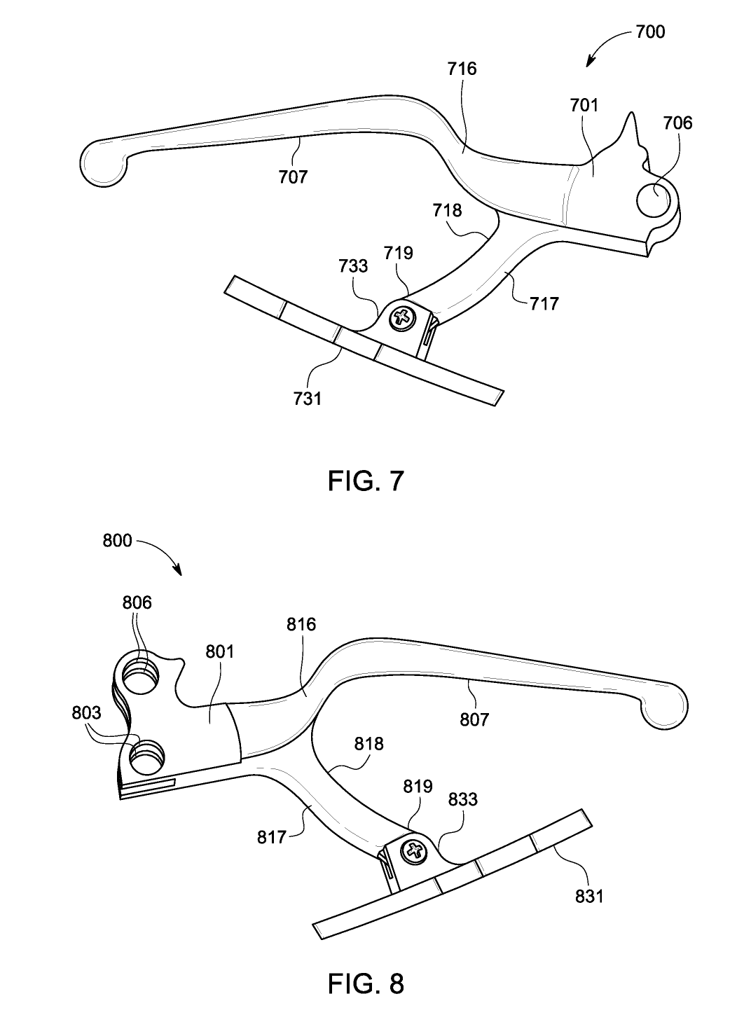

FIG. 7 is a top view of personalized front brake hand operating lever of a motorcycle. A front brake lever assembly 700 includes a head portion 701, a connector portion 716 positioned between the head portion and a finger-engaged lever portion 707. The head portion 701 contains at the proximal end an opening 706 for receiving a hinge pin for mounting front brake lever 700 to the handgrip by means of a clamp. Beginning near the proximal end of the handgrip assembly 700 and spaced apart from the handlebar handgrip by a connector 716, the hand lever 707 by which the brake is operated extends outwardly in a typical fashion.

The present invention includes a head extension 717 extending outwardly from the connector portion 716 of the front brake lever. The proximal end 718 of the head extension 717 may be formed integrally with the connector portion 716 of lever 707, or it may be attached to the connector by any typical means, such as welding, brazing, bolting, screwing or gluing. The distal end 719 of the head extension 717 terminates in a male configuration adapted to receive the slotted female configuration 733 at the rear of one of the elements of the display 731.

FIG. 8 is a top view of personalized clutch hand operating lever of a motorcycle. A clutch lever assembly 800 includes a head portion 801 and a finger-engaged lever portion 807 connected by a connector portion 816. The head portion 801 contains at the proximal end an opening 806 for receiving a hinge pin for mounting clutch lever 800 to the handlebar. Beginning near the proximal end of the clutch hand operating lever assembly 800 and spaced apart from the handlebar handgrip by a connector 816, the hand lever 807 by which the clutch is operated extends outwardly in a typical fashion. The present invention includes a head extension 817 extending outwardly from the connector 816 positioned between head portion 801 and the clutch lever handle portion adapted for the operator's fingers to clasp. The proximal end 818 of the head extension 817 may be formed integrally with the connector 816, or it may be attached to the connector by any typical means, such as welding, brazing, bolting, screwing or gluing. The distal end 819 of the head extension 817 terminates in a male-configuration adapted to receive the slotted female configuration 833 at the rear of one of the elements of the display 831.

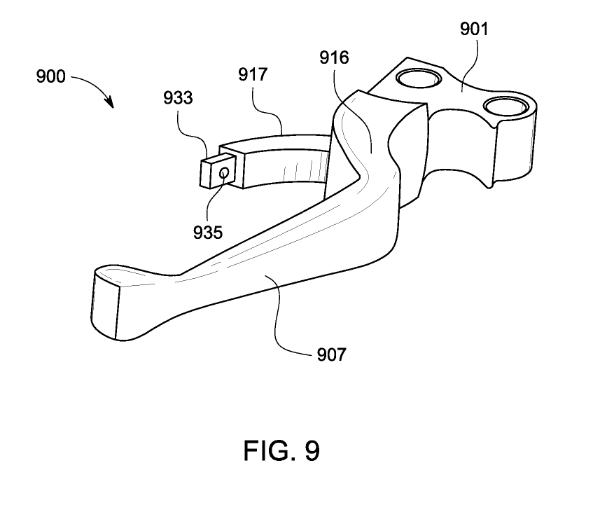

FIG. 9 is a perspective view of a personalized clutch lever 900 with a head extension 917 for the exhibitor display. The clutch lever head assembly 901 is connected by a connector 916 to the handle portion 907 of the clutch lever assembly. Connector 916 is a reverse ogee curve, having an inner surface facing a handgrip, and an outer surface facing away from the handgrip. Attached to the outer surface of connector 916 is an extension 917 which is roughly quadrilateral in cross section and which terminates in a male member 933 adapted to be fitted to a female end on the exhibitor display, and secured by a machine screw through hole 935.

### DETAILED DESCRIPTION OF THE PREFERRED EMBODIMENTS

The personalized exhibitor display for the hand lever of the present can consist of any combination of numbers, letters or other symbols and generally will be from 2 to 6 joined symbols such as an area code, zip code, club initials or insignia or a person's initials. For example, FIG. 1 displays the telephone area code 510, which is used in the East Bay area of San Francisco Bay. FIG. 2 shows the abbreviation NorCal, and FIG. 3 displays the area code 650, representing the San Francisco Peninsula. Insignia like JESUS can be used for those religiously inclined, or a logo, such a as skull and crossbones, a flag, or a winged skull for the Hells Angels can be used. The limit is what one can imagine. Individual symbols will typically be joined at the side edges so that the resulting personalized display can be attached to the lever head extension and extend outwardly more or less roughly on the same plane or even parallel to the hand lever for controlling the clutch or front brake, but with space for the fingers of the vehicle operator.

The individual symbols in any display can be selected by the owner and joined together in any combination to depict the personalized aspect desired by the owner. It will be recognized that the symbols forming the personalization can be joined by casting them jointly as one unit, or welding them, or even securing them by other means such as bolting, screwing or gluing. The individual symbols will be three-dimensional, and thick enough to retain structural integrity if the personalized display is accidentally bumped. Another benefit of the personalized display is that it will protect the finger of the rider if the motorcycle encounters bushes or shrubs that encroach upon the right-of-way.

In another aspect of the present invention, it will be noted that the personalized display can be either be formed integrally with the head extension or connector, i.e., cast integrally with the hand lever, or they may be welded or otherwise permanently joined together. In another embodiment, the display is removably fastened to the connector or head extension of the clutch or front brake lever so that the display can be removed and replaced merely by removing the fastener such as a pin, bolt or screw securing them and exchanging the personalized insignia with the one currently desired, then replacing the fastener. The display will contain a mounting means on the side or rear of one of the symbols, such as one portion of a tongue and groove assembly, while the head extension of the lever will contain the other portion of the mounting means, which will either be formed integrally with it, or fastened to it by customary means such as welding. In one aspect, the display will have a mounting means such as a groove or a slot, while the head extension of the operating lever will contain the tongue or male component. In another aspect, the position of the male and female connector components will be reversed. The two components can be secured to each other by means of a machine screw, pin, or bolt, or other customary means. The display is typically secured to the head extension in a fixed position, so that it is fixed in position and does not pivot once it is secured. It will also be noted that upon operation of the clutch or front brake lever to engage the clutch or brake, typically by pulling the lever toward the handgrip, the personalized display will move together with the operating levers.

In another embodiment of the present invention, there is a reverse face curvature in the connector between the head portion and the handle portion of the lever that the fingers clasp. The handle portion of the front brake and clutch levers is spaced away from the head portions by the connector, which is shaped as a reverse ogee curve, and the head extension to which the exhibitor display is attached is secured to the outward face of the connector, away from the handgrip. The reverse face curvature of the connector, facing away from the handgrip, has an irregular curved quadrilateral midsection which protrudes a sufficient distance to allow finger clearance. The extension is also curved to allow the exhibitor device to connect in a position near parallel or parallel relational with the handlebar of the vehicle while allowing space for the fingers of the operator to grasp the handle portion of the lever. Midpoints of the face curvature proximal to the head portion and the irregular curved quadrilateral midsection are coincidentally fixed.

It can be seen that between the head portion and handle portion of the lever assembly and extending away from the head portion at the midpoint of face curvature away from the handgrip is an irregularly curved quadrilateral section which protrudes from and is integrally connected with the connector portion of the hand operating lever assembly. The extension of the present invention is connected to the midpoint of the face curvature of the reverse ogee curve of the connector proximal to the front view face of the head portion of the operating lever. The center of the irregular curved quadrilateral midsection of the extension is established at the midpoint of the face curvature that is proximate to the head section away from the handgrip and adapted for structural coherence that reinforces the hand lever portion. The irregular curved quadrilateral midsection protrudes a distance from the hand lever, allowing finger clearance between the finger engaged handle lever portion and the exhibitor display, and adapting the exhibitor display to connect in a position near parallel or parallel in relation to the handgrip or hand lever. Midpoints of the face curvature proximal to the head portion and the irregular curved quadrilateral midsection are coincidentally fixed. It will be understood that the present invention will not disturb the normal operating parameters of a clutch control cable, or a brake control, one end of which is typically functionally connected to a motorcycle clutch or the motorcycle brake.

In yet another aspect, the head extension of the present invention at roughly the midpoint has a curved quadrilateral cross-section which is adapted for structural coherence that reinforces the hand operated lever where the lever is joined to the head or connector portion of the clutch or brake assembly.

In operation it is sufficient to understand that the vehicle operator will grip the hand-grips of the handlebar with his or her palms, and the fingers of each hand will commonly engage the handle portion of the hand lever to affect control the clutch and front brake operating lever. Each of these levers is pivotally mounted on a bracket secured to the motorcycle handlebar adjacent to the handgrip. Operating the clutch lever operates a clutch control cable whose other end is connected to the motorcycle clutch. The head portion of the clutch hand lever includes a pair of feet for receiving between them an eyelet on the clutch control cable, and each foot on the clutch control cable includes an aperture for receiving an anchor. There is also a hinge formed on the head portion there the lever can be secured to the handlebar by means of a hinge pin. It will be valued that pivotal movement of the lever toward and away from the handgrip will cause the front brake or the clutch in a manner noted in the art.

It should be appreciated that although the description herein has focused on the personalized display adapted use with the clutch hand operating lever of a vehicle such as a motorcycle, all terrain vehicle, jet-ski, scooter, or bicycle, the same principles and functions will apply on the front brake operating lever of the same vehicles.

The handle portions of both the clutch lever and the front brake lever have an inner surface facing the handgrip and an outer surface facing away from the handgrip. In addition there is a pair of side surfaces. It can be seen that the adaption of the head extension of the present invention is a surface that extends away from the connector attached to the head portion of the operating lever at roughly the midpoint of face curvature of the connector and away from the handgrip in an irregularly curved quadrilateral section which protrudes and is joined to the personalized display of one or more three-dimensional symbols. In alternative embodiments, the head extension can have an oval, trapezoidal or triangular cross-section. The head extension extends away from the handle portion in a concave arc, then the display extends roughly in the same plane and roughly parallel to the handle portion of the hand lever, so as to provide an opening between the lever and the personalized display whereby the operator's fingers will comfortably easily fit through it.

In another aspect, the invention comprises a personalized hand lever assembly for operating a vehicle (such as a hand lever of a motorcycle), the vehicle having a handlebar and a pair of handgrips on the opposite ends of the handlebar for steering, each handgrips having a longitudinal axis and being a curvilinear in a section transverse to its longitudinal axis, the personalized hand lever including a head portion proximal to and functionally connected to the handlebar adjacent one of the handgrips and serving to engage a front brake or clutch mechanism, said proximal end being adapted to be pivotally mounted on the handlebar. The personalized hand lever assembly also includes on the distal end, a lever portion capable of being engaged by fingers of the operator, and a connector connecting the lever portion to the head portion, the connector positioning the personalized lever so that it can be engaged by the operator's fingers, the improvement in the personalized hand operating lever comprising an irregular curved quadrilateral extension extending from the connector at the side opposite the handgrip, and at the distal end connected to one or more three dimensional symbols, such as numbers and or letters.

The personalized hand operating lever assembly also comprises a handle portion engageable by the fingers of the operator of the vehicle, the handle portion being positioned between the proximal end attached to a connector attached to the head portion, and a distal end of the lever. Said handle portion of the lever extends outwardly from a connector attached to the head portion of the lever assembly and is adapted to be pivoted by the operator's fingers from a normal position in which the distal end of the lever is spaced apart from a handgrip to a second position when the lever is engaged in which the distal end is adjacent to the hand grip.

Said handle portion has an inner surface adapted to face a handgrip and an outer surface adapted to face away from the handgrip, and a pair of sides disposed at the junction of the inner and outer surfaces, said sides of personalized hand lever tapering along inwardly from adjacent its proximal end to adjacent its distal end, the inner surface extending from tangent point being concave in transverse section and generally linear in the direction extending from adjacent the distal end to adjacent the proximal end to define a generally cylindrical section complimentary to the outer surface of a handgrip, the nonparallel outer surface extending from tangent point being convex or parabolic in transverse section.

Also, said handle portion reinforces the form of a multi functional personalized hand lever and is connected to a connector portion, which connector extends away from the head portion and comprises a reverse ogee curvature in transverse cross section connected to two nonparallel surfaces away from the handgrip at opposite ends, and at approximately the midpoint of a face curvature of the connector, facing away from the handgrip, an irregular curved quadrilateral extension extends roughly parallel to and spaced apart from the finger engaged handle lever portion of the personalized operating lever assembly.

A display of one or more symbols can be removably connected to or formed integral with the distal end of the extension. In one embodiment, there is a plurality of three dimensional symbols, including letters or numbers which may be selected from a particular font set of letters or numbers whereby definite personalized information is conveyed to an observer.

The personalized hand lever is adapted to pivot towards a handgrip when engaged by the finger of the operator, whereby said flat or concave inner surface of the hand grip is moveable toward nearness with the curvilinear surface of a handgrip, said handle portion being thicker in its center between said edges and tapering to the edges which are relatively thinner than the center and whereby the convex or parabolic outer surface is adapted to define a generally oval configuration with a handgrip in a section transverse to the longitudinal axis of the handle portion which an operator's fingers clasps when the personalized lever is in near proximity with a handgrip, thereby allowing suitable clearance for operator's fingers to clasp the handle portions of the personalized lever between the convex or parabolic outer surface of the lever and the inward side of the exhibitor display face toward the convex or parabolic surface of the handle portions.

Thus, the benefits of the operation the personalized display of the present invention produces an eye pleasing appearance no matter whether the vehicle is in motion or stopped, reinforces the hand operating levers, and protects the fingers of the operator.

Those skilled in the art will appreciate that the personalized display in conjunction with hand operating lever devices according to the preferred embodiment of the invention may also be employed on other types of vehicles which may employ handgrips such as bicycles snowmobiles and the like. Only a few embodiments of the invention have been illustrated and described, they are not intended to be limited thereby, but only by the scope of the appended claims.

What is claimed is:

1. For a vehicle having a handlebar for steering and a pair of handgrips on opposite ends of the handle bar,
each handgrip having a longitudinal axis, and a hand lever assembly pivotably associated with each hand grip for controlling the operation of a vehicle,
the hand lever having two ends and a middle, the middle and the distal end of which extend outwardly from the center of the handlebar and roughly parallel with the hand grip so as to be readily engaged by the fingers of an operator of the vehicle,
and a proximal end of the hand lever which comprises a head operably connected to the handlebar;
the proximal end of the hand lever assembly being connected to the middle by a connector;
the invention which comprises:
an extension extending from the connector adjacent to the proximal end of the lever, which extension extends concavely outwardly from the outer surface of the hand lever facing away from and roughly horizontal to the handgrip section of the handlebar when the vehicle is in operation,
the extension which at its distal end is adapted to receive a personalized three-dimensional exhibitor display comprising one or more symbols.

2. The extension of claim 1 further comprising a personalized three dimensional exhibitor display removably attached to the distal end of the extension and comprising one or more symbols which extend roughly parallel to the handgrip of the handlebar and the hand lever.

3. The exhibitor display of claim 2 wherein the display symbols are joined together.

4. The exhibitor display of claim 2 wherein the display comprises from 3 to 5 symbols.

5. The exhibitor display of claim 4 wherein the display comprises from 3 to 5 letters or numbers.

6. The exhibitor display of claim 1 wherein a personalized three dimensional exhibitor display is formed integrally with the lever extension.

7. The exhibitor display of claim 6 wherein the display is ferrous or non-ferrous metal.

8. The vehicle of claim 1 wherein the lever is selected from the group consisting of a clutch hand lever and a front brake hand lever.

9. The vehicle of claim 1 wherein the vehicle is selected from the group consisting of motorcycles, motor scooters, snowmobiles, jet skis and all-terrain vehicles.

10. A personalized exhibitor display for a hand lever for controlling the operation of a vehicle,
the vehicle having a handlebar for steering and a pair of handgrips on opposite ends of the handle bar,
each handgrip having a longitudinal axis and
a hand lever pivotably associated with each hand grip, the hand lever having a head portion proximal to the handlebar, a middle portion, a distal portion, and a connector between the proximal portion and the middle portion,
the middle portion of the lever which extends outwardly from the center of the handlebar away from the head portion and the connector, and roughly parallel with the hand grip so as to be readily engaged by the fingers of an operator of the vehicle
and a head extension extending outwardly from the connector, which extension extends concavely outwardly from and roughly horizontally from and parallel to the handlebar when the motorcycle is in operation,
the extension which at its distal end is adapted to receive a personalized three dimensional exhibitor display comprising one or more symbols which extend roughly parallel to the hand lever.

11. The display of claim 10 wherein the display consists of from three to five symbols.

12. The display of claim 11 wherein the display consists of from three to five letters or numbers.

13. The display of claim 10 wherein the display is formed integrally with the hand lever.

14. A personalized hand lever for a motorcycle, the personalized hand lever having an exhibitor display, the hand lever having a head portion operably connected to the handlebar of a motorcycle to allow the lever to control the front brake or clutch thereof, a connector portion between the head portion and a handle portion of the lever, and an extension extending outwardly from the connector away from the handlebar to which is connected the exhibitor display, which display comprises one or more three-dimensional symbols.

15. The display of claim 14 wherein the display consists of from three to five symbols.

16. The display of claim 15 wherein the symbols are letters or numbers.

17. The hand lever of claim 14 wherein the display is permanently fixed to the connector.

18. The hand lever of claim 14 wherein the display is formed integrally with the connector.

19. The hand lever of claim 14 wherein the display is removably connected to the connector.
